(19) United States
(12) Patent Application Publication
(10) Pub. No.: US 2016/0104074 A1
(43) Pub. Date: Apr. 14, 2016

(54) Recommending Bidded Terms

(71) Applicant: Yahoo! Inc., Sunnyvale, CA (US)

(72) Inventors: Ajay SHEKHAWAT, San Francisco, CA (US); Mihajlo GRBOVIC, Mountain View, CA (US)

(21) Appl. No.: 14/512,187

(22) Filed: Oct. 10, 2014

(51) Int. Cl. G06N 99/00; G06Q 30/02; G06F 17/30

(52) U.S. Cl. CPC G06N 99/005; G06F 17/30705; G06Q 30/0276

(57) ABSTRACT

Systems and methods for recommending bidded terms are disclosed. The system collects a plurality of bidded terms and separates them into ad groups. The add groups are then combined into sequences of terms, which are fed into a deep learning network to build a multidimensional word vector in which related terms are nearer one another than unrelated terms. An input term is then received and the system matches the input term in the multidimensional word vector and recommends the nearest neighbors to the term.

### BACKGROUND

1. Technical Field

The disclosed embodiments are related to Internet advertising and more particularly to systems and method for recommending terms for bidding in a sponsored search marketplace.

2. Background

Internet advertising is a multi-billion dollar industry and is growing at double-digit rates in recent years. It is also the major revenue source for internet companies such as Yahoo!® that provide advertising networks that connect advertisers, publishers, and Internet users. As an intermediary, these companies are also referred to as advertiser brokers or providers. New and creative ways to attract attention of users to advertisements (“ads”) or to the sponsors of those advertisements help to grow the effectiveness of online advertising, and thus increase the growth of sponsored and organic advertising. Publishers partner with advertisers, or allow advertisements to be delivered to their web pages, to help pay for the published content, or for other marketing reasons.

Search engines assist users in finding content on the Internet. In the search ad marketplace, ads are displayed to a user alongside the results of a user's search. Ideally, the displayed ads will be of interest to the user resulting in the user clicking through an ad. In order to increase the likelihood of displaying an ad to a user, an advertiser may bid on multiple keywords for displaying their ad, rather than a single keyword. While an advertiser may be able to easily identify keywords for bidding based on their knowledge of the market, other keywords may escape the advertiser. These keywords represent a lost opportunity for the advertiser to display their ad to an interested user, as well as a lost sales opportunity for the ad broker.

Because the search provider often has the most information regarding keyword searches and user behavior, they are often the best situated to identify keywords that may otherwise be overlooked. To help the advertiser, and to increase their search ad marketplace, brokers in the past have developed systems for recommending keywords to advertisers. These systems may be relatively simple, such as a broker manually entering words they believe to be related, to more advanced techniques such as query-log mining, based on related searches, co-biddedness, based on advertisers bidding on similar keywords, and search URL overlap, in which different keywords result in the same set of search URLs.

The described systems are each successful in their own way to suggest keywords to advertisers. However, they do not necessarily capture all of the related keywords that an advertiser may be interested in, or they may suggest some keywords that are actually of little value to the advertiser. It would be beneficial to develop a different system for recommending keywords that returned results that may be overlooked by current systems, while limiting the recommendation of keywords having little value to the advertiser.

### BRIEF SUMMARY

In one aspect, a computing system for recommending terms is disclosed. In one embodiment, the computing system includes a grouping module, a learning module, and a term recommendation module. The grouping module is configured to receive a plurality of bidded terms, and group bidded terms within the plurality of bidded terms into term sequences. The learning module is configured to receive the term sequences and embed terms contained in the plurality of bidded term sequences in a multidimensional word vector. The term recommendation module is configured to receive a term, find the nearest neighbors of the term in the multidimensional word vector, and recommend the nearest neighbors of the term.

In some embodiments, the grouping module is further configured to receive creatives associated with the bidded terms, and group the creatives with corresponding term sequences.

In some embodiments, the terms contained in the plurality of term sequences consists of terms bidded on by a plurality of advertisers. In some embodiments, the term sequences are grouped according to an ad group.

In some embodiments, the nearest neighbor is found using the cosine distance metric.

In another aspect, a method for recommending terms is disclosed. In one embodiments, the method includes collecting a plurality of bidded terms having corresponding ad groups, grouping bidded terms from among the plurality of bidded terms into groups that have a common ad group to form term sequences, inputting the term sequences into a deep learning network to embedding terms from among the term sequences in a multidimensional word vector in which related terms are found close to one another, receiving an input term, locating the input term in the multidimensional word vector, finding a plurality of nearest neighbors to the input term in the multidimensional word vector, and recommending the plurality of nearest neighbors of the input term.

In some embodiments, the plurality of bidded terms comprises terms previously bid upon by advertisers. In some embodiments, the nearest neighbors are determined through a cosine distance metric. In some embodiments, the multidimensional word vector has greater than 200 dimensions.

In another aspect, a computer program product for recommending terms is disclosed. The computer program product includes a non-transient computer readable storage media have instructions stored thereon that cause a computing device to perform a method. In one embodiment the method includes receive a bidded term, access a multidimensional word vector of interconnected bidded terms to find a plurality of related bidded terms spatially near the bidded term in the multidimensional word vector, and recommend the plurality of nearest neighbors of the bidded term.

In some embodiments, the multidimensional word vector comprises an output of a deep learning network trained with a plurality of term sequences having a common grouping as an input.

In some embodiments, the instruction further cause the computing device to build the multidimensional word vector. In some embodiments, building the multidimensional word vector includes collecting a plurality of bidded terms having corresponding group identifiers, grouping bidded terms from among the plurality of bidded terms that have a common group identifiers to form term sequences, and inputting the term sequences into a deep learning network to embed each term in a multidimensional word vector in which related terms are found close to one another.

In some embodiments, the input term comprises a bidded term and the plurality of nearest neighbors comprises recommended bidded terms. In some embodiments, the bidded term comprises a multi-word phrase. In some embodiments, the learning module operates on the plurality of word sequences in a sliding window fashion. In some embodiments, each sequence of words is a context.

### BRIEF DESCRIPTION OF THE DRAWINGS

FIG. 1 illustrates an exemplary embodiment of a network system suitable for practicing the invention.

FIG. 2 illustrates a schematic of a computing device suitable for practicing the invention.

FIG. 3 illustrates a high level system diagram of a system for recommending bidded terms.

FIG. 4 illustrates a flowchart of a method for recommending terms for bidding.

FIG. 5 illustrates a flowchart of an embodiment of a method for recommending terms for bidding.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, the disclosed embodiments relate to systems and methods for recommending terms. The systems and methods are able to recommend bidded terms in a search ad marketplace using only the information provided by the customers bidding and does not rely on search histories or query logs.

### Network

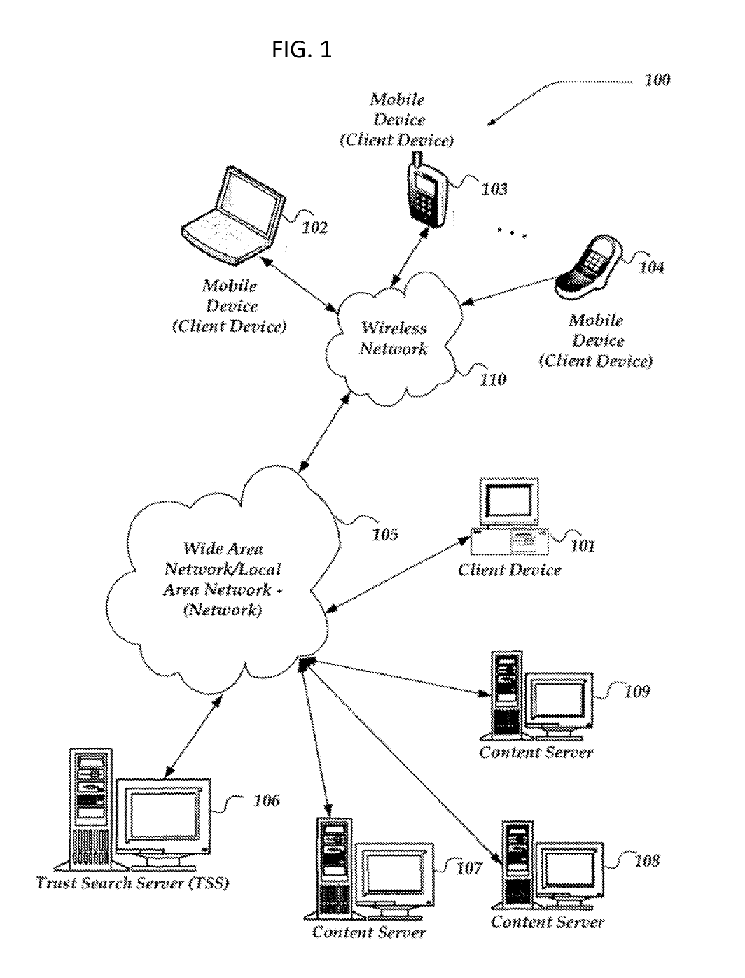

FIG. 1 is a schematic diagram illustrating an example embodiment of a network 100 suitable for practicing the claimed subject matter. Other embodiments may vary, for example, in terms of arrangement or in terms of type of components, and are also intended to be included within claimed subject matter. Furthermore, each component may be formed from multiple components. The example network 100 of FIG. 1 may include one or more networks, such as local area network (LAN)/wide area network (WAN) 105 and wireless network 110, interconnecting a variety of devices, such as client device 101, mobile devices 102, 103, and 104, servers 107, 108, and 109, and search server 106.

The network 100 may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

### Computing Device

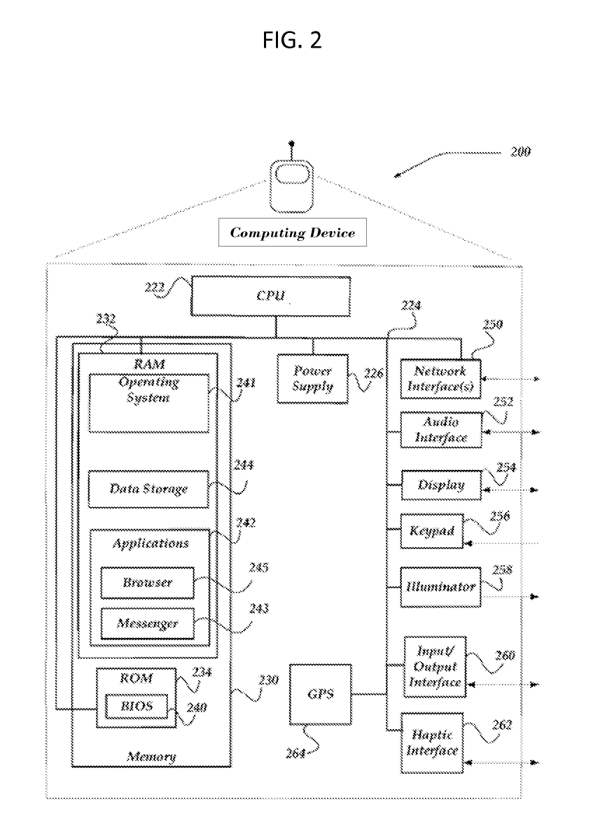

FIG. 2 shows one example schematic of an embodiment of a computing device 200 that may be used to practice the claimed subject matter. The computing device 200 includes a memory 230 that stores computer readable data. The memory 230 may include random access memory (RAM) 232 and read only memory (ROM) 234. The ROM 234 may include memory storing a basic input output system (BIOS) 230 for interfacing with the hardware of the client device 200. The RAM 232 may include an operating system 241, data storage 244, and applications 242 including a browser 245 and a messenger 243. A central processing unit (CPU) 222 executes computer instructions to implement functions. A power supply 226 supplies power to the memory 230, the CPU 222, and other components. The CPU 222, the memory 230, and other devices may be interconnected by a bus 224 operable to communicate between the different components. The computing device 200 may further include components interconnected to the bus 224 such as a network interface 250 that provides an interface between the computing device 200 and a network, an audio interface 252 that provides auditory input and output with the computing device 200, a display 254 for displaying information, a keypad 256 for inputting information, an illuminator 258 for displaying visual indications, an input/output interface 260 for interfacing with other input/output devices, haptic feedback interface 262 for providing tactile feedback, and a global positioning system 264 for determining a geographical location.

### Client Device

A client device is a computing device 200 used by a client and may be capable of sending or receiving signals via the wired or the wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features and need not contain all of the components described above in relation to a computing device. Similarly, a client device may have other components that were not previously described. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

### Servers

A server is a computing device 200 that provides services. Servers vary in application and capabilities and need not contain all of the components of the exemplary computing device 200. Additionally, a server may contain additional components not shown in the exemplary computing device 200. In some embodiments a computing device 200 may operate as both a client device and a server.

### Deep Learning Networks in Non Linear Programming (NLP)

Language models play an important role in many NLP applications, especially in information retrieval. Traditional language model approaches represent a word as a feature vector using a one-hot representation—the feature vector has the same length as the size of the vocabulary, where only one position that corresponds to the observed word is switched on. However, this representation suffers from data sparsity. For words that are rare, corresponding parameters will be poorly estimated.

Inducing low dimensional embeddings of words by neural networks has significantly improved the state of the art in NLP. Typical neural network based approaches for learning low dimensional word vectors are trained using stochastic gradient via back propagation. Historically, training of neural network based language models has been slow, which scales as the size of the vocabulary for each training iteration. A recently proposed scalable continuous Skip-gram deep learning model for learning word representations has shown promising results in capturing both syntactic and semantic word relationships in large news articles data.

The Skip-gram model is designed to train a model that can find word representations that are capable of predicting the surrounding words in a document. The training objective is stated as follows. Assume a sequence of words w₁, W₂, W₃, . . . , W_{T} in a document used for training, and denote by V the vocabulary, a set of all words appearing in the training corpus. The algorithm operates in a sliding window fashion, with a center word w and k surrounding words before and after the central word, which is referred to as context c. It is possible to use a window of different size. It may be useful to have a of words forming a document in which each word within the document is related to one another. The window may then be each document such that all terms in a sequence are considered related, rather than just k surrounding words. This may be accomplished by using an infinite window for each document making up the training data. The parameters θ to be learned are the word vectors v for each of the words in the corpus.

At each step of the sliding window process the conditional probabilities of context are considered given the word [symbol] (c|w). For a single document, the parameters θ that maximize the document corpus probability, given as

$$arg max {\prod }_{t = 1}^{T} {\prod }_{- k \leq j \leq j \neq t} ℙ ( {w}_{t + j} \vert {w}_{t} ; θ )$$

Considering that training data may contain many documents, the global objective may be written as

$$arg max {\prod }_{( w , c ) ∈ D}^{T} ℙ ( c \vert w ; θ )$$

where D is the set of all word and context pairs in the training data.

Modeling the probability [symbol] (c|w, θ) may be done using a soft-max function, as is typically used in the neural-network language models. The main disadvantage of the presented solution is that it is computationally expensive. The term [symbol] (c|w, θ) is very expensive to compute due to the summation over the entire vocabulary, therefore making the training complexity proportional to size of the training data that may contain hundreds of thousands of distinct words.

Significant training speed-up may be achieved when using a hierarchical soft-max approach. Hierarchical soft-max represents the output layer (context) as a binary tree with |V| words as leaves, where each word w may be reached by a path from the root of the tree. If n(w,j) is the j-th node on that path to word w, and L(w) is the path length, the hierarchical soft-max defines probability [symbol] (w|wᵢ) as

$$ℙ ( w \vert {w}_{i} ) = {\prod }_{j = 1}^{L ( w ) - 1} σ ( {v}_{n ( w , j )}^{T} \cdot {v}_{{w}_{i}} )$$

where σ(x)=1/(1+exp(−x)). Then, the cost of computing the hierarchical soft-max approach is proportional to log |V|. In addition, the hierarchical soft-max skip-gram model assigns one representation v_{w} to each word, and one representation vₙ for every inner node n of the binary tree, unlike the soft-max model in which each word had context and word vectors v_{c} and v_{w}, respectively.

In the examples that follow, this general approach may be used with sequences of bidded terms comprising the training data. The vocabulary may be the entire set of words contained within the bidded terms, or it may be a subset of words with unimportant or common words removed. Other approaches for training a model that can find word representations that are capable of predicting the surrounding words in a document may be used. For example, Word2vec, a popular open-source software, is readily available for training low dimensional word vectors. However, previous work, such as Word2vec, has focused in capturing word relationships with respect to everyday language. As such, the Word2vec tool is trained using a corpus of common web phrases, such as those found on Wikipedia.

### Overview

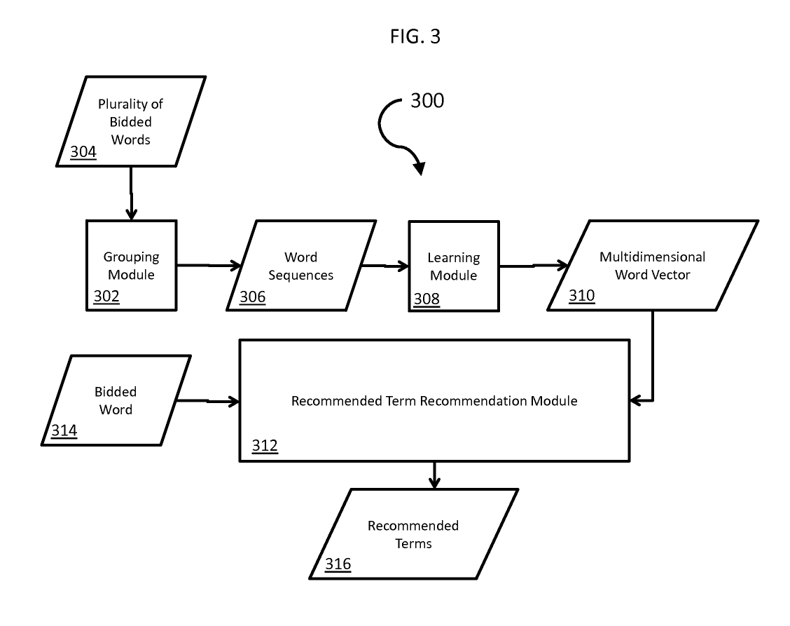

FIG. 3 illustrates a high level system diagram of a computing system 300 for recommending terms. The system 300 may be executed as hardware or software modules on a computing device as shown in FIG. 2, or as a combination of hardware and software modules. The modules may be executable on a single computing device or a combination of modules may each be executable on separate computing devices interconnected by a network. FIG. 3 illustrates the system 300 with each module component being connected directly to one another, but they need not be. For example, each module could be connected to a communications bus to communicate between the modules. The arrows as shown on the diagram are for clarity in illustrating the general flow of data.

The grouping module 302 is configured to receive a plurality of bidded terms 304 and group the bidded terms 304 into term sequences 306. The plurality of bidded terms 304 may be terms which a plurality of advertisers are bidding on. Each of the bidded terms 304 may be associated with an ad group. For example, an ad group of car insurance advertisements may have advertisers bidding on terms such as insurance, auto, auto insurance, insurance, and ad group of real estate advertisements may have advertisers bidding on terms such as real estate, housing, moving, and relocate. Because there are multiple advertisers within each ad group, and each advertiser may participate in multiple ad groups, the bidded terms 304 may initially be unorganized. The grouping module 302 may group the plurality of bidded terms 304 into groups according to their ad group to form term sequences 306. Each term group may form a single sequence of terms 306. In some instances, the plurality of bidded terms 304 may be grouped prior to submission to the grouping module, in which instance the grouping module 302 may divide the plurality of bidded terms 304 into term sequences 306 without initially grouping them.

The grouping module 302 may further receive creatives (Title, Description, URL) that are contained in the ad group associated with the plurality of bidded terms 304. The creatives may be ignored, or keywords within the creatives may be extracted and added to the term sequences 306 corresponding to that AdGroup.

The term sequences 306 are input into a learning module 308. The learning module 308 is configured to embed terms contained in the plurality of term sequences 306 into a multidimensional word vector 310, in which related terms are found in close proximity. One example of an exemplary learning module 308 is the open source word2vec program. The output of the learning module 308 is a multidimensional word vector 310. The multidimensional word vector 310 may have between 200 to 300 dimensions.

The multidimensional word vector 310 is input into a recommendation module 312. The recommendation module 312 also receives a bidded term 314 from an advertiser. The recommendation module 312 locates the bidded term 314 within the multidimensional word vector 310 and calculates the bidded term's 314 nearest neighbors. The nearest neighbors may be calculated using a common distance function such as a cosine distance metric. The top scoring neighbors are selected for recommending to the advertiser. The number of top scoring members may be selected based on user preferences, a minimum score threshold, or other technique for selecting the number of terms to recommend. The top scoring neighbors are then output as recommended terms 316, and the advertiser may be given the option to select at least one of the recommended terms 316 for additional bidding.

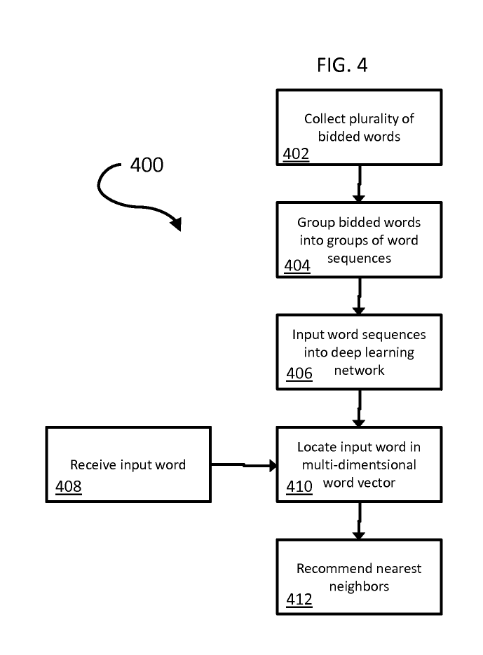

Embodiments are further directed to a method for recommending bidded terms. The method may be performed using the system of FIG. 3. FIG. 4 illustrates a high level flowchart of a method 400 for recommending bidded terms. In the method 400, at block 402, a plurality of bidded terms having corresponding ad groups are collected. The ad groups may be collected by maintaining a historical record of terms bidded on by advertisers. In another embodiment, the bidded terms may be determined in real-time as various advertisers bid on different key terms. Or in still other embodiments, the bidded terms may be generated by another source and collecting bidded terms may include receiving the bidded terms from the other source.

In block 404, the bidded terms are grouped into groups having a common advertisement group. The groups may be defined strictly, or they may be more general depending on the need for accuracy or the availability of bidded terms. The groups of terms form term sequences having a common ad group, indicating that they are related. The grouping of the bidded terms may be performed by the grouping module 302 of FIG. 3.

In block 406, the term sequences are input into a deep learning network configured to determine relationships between terms. The deep learning network embeds terms from among the term sequences in a multidimensional word vector in which relative strength of the relation between terms is determined by the distance between terms. The deep learning network may be the learning module 308 of FIG. 3. The result of inputting the term sequences into the deep learning network is a multidimensional word vector in which related terms are spatially near one another. The multidimensional term vector may have more than 200 dimensions.

In block 408, an input term is received. The input term may be a term that is being bid upon by at least one advertiser. In block 410, the input term is located in the multidimensional word vector. Once the input term is location, its nearest neighbors are found in block 412. The nearest neighbors may be determined using recommendation module 312 from FIG. 3. As described previously, the cosine distance metric may be used to determine the nearest neighbors. In block 314, the nearest neighbors are recommended as terms for bidding and an advertiser may then select a recommended bidded term for additional bidding.

In another embodiment, another method for recommending terms is disclosed. The method may be embodied as a computer program product for recommending terms. The computer program product may comprise non-transient computer readable storage media having instructions stored thereon that cause a computing device to perform the method.

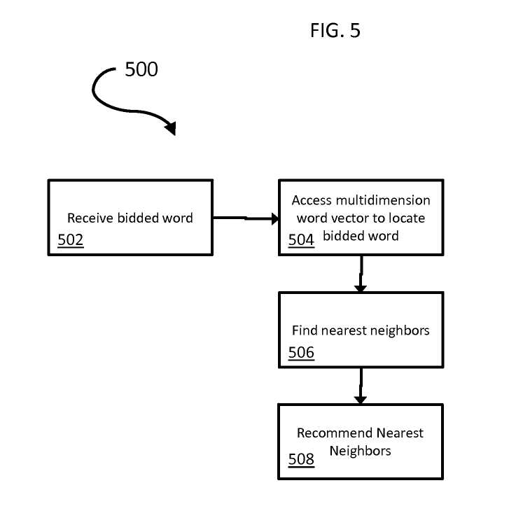

FIG. 5 is a high level flow chart of the embodiment of the method for recommending terms. This method may be performed in the recommendation module of FIG. 3. In block 502 a bidded term is received. In block 504, a multidimensional word vector of interconnected bidded terms is accessed to find a plurality of nearest neighbors. In block 506, the nearest neighbors are recommended. The multidimensional word vector may comprise an output of a deep learning network trained with a plurality of bidded term sequences having a common ad group as an input.

The method may further comprising building the multidimensional word vector. The multidimensional word vector may be built by collecting a plurality of bidded terms having associated ad groups, grouping bidded terms from among the plurality of bidded terms that have a common ad groups to form bidded term sequences; and then inputting the bidded term sequences into a deep learning network to embedding each term in a multidimensional vector in which related terms are found close to one another.

From the foregoing, it can be seen that the present disclosure provides systems and methods for recommending bidded terms without having to rely on a search history, or query logs. The recommended terms are relevant in the context of interest to the advertiser, while requiring no data beyond that provided by advertisers when they bid on terms.

While various embodiments have been described above, it should be understood that they have been presented by way of example only, and not limitation. It will be apparent to persons skilled in the relevant arts) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A computing system for recommending terms, comprising:
a grouping module configured to receive a plurality of bidded terms, and group bidded terms within the plurality of bidded terms into term sequences;
a learning module configured to receive the term sequences and embed terms contained in the plurality of bidded term sequences in a multidimensional word vector; and
a term recommendation module configured to receive a term, find the nearest neighbors of the term in the multidimensional word vector, and recommend the nearest neighbors of the term.

2. The computing system of claim 1, wherein the terms contained in the plurality of term sequences consists of terms bidded on by a plurality of advertisers.

3. The computing system of claim 1, wherein the nearest neighbor is found using the cosine distance metric.

4. The computing system of claim 1, wherein the term sequences are grouped according to an ad group.

5. The computing system of claim 1, wherein the grouping module is further configured to receive creatives associated with the bidded terms, and group the creatives with corresponding term sequences.

6. A method for recommending terms, the method comprising:
collecting a plurality of bidded terms having corresponding ad groups;
grouping bidded terms from among the plurality of bidded terms into groups that have a common ad group to form term sequences;
inputting the term sequences into a deep learning network to embedding terms from among the term sequences in a multidimensional word vector in which related terms are found close to one another;
receiving an input term;
locating the input term in the multidimensional word vector;
finding a plurality of nearest neighbors to the input term in the multidimensional word vector; and
recommending the plurality of nearest neighbors of the input term.

7. The method of claim 6, wherein the plurality of bidded terms comprises terms previously bid upon by advertisers.

8. The method of claim 6, wherein the nearest neighbors are determined through a cosine distance metric.

9. The method of claim 6, wherein the multidimensional word vector has greater than 200 dimensions.

10. A computer program product for recommending terms, the computer program product comprising non-transient computer readable storage media have instructions stored thereon that cause a computing device to perform a method comprising:
receive a bidded term;
access a multidimensional term vector of interconnected bidded terms to find a plurality of related bidded terms spatially near the bidded term in the multidimensional word vector;
recommend the plurality of nearest neighbors of the bidded term.

11. The computer program product of claim 10, wherein the multidimensional word vector comprises an output of a deep learning network trained with a plurality of term sequences having a common grouping as an input.

12. The computer program product of claim 11, wherein the instruction further cause the computing device to build the multidimensional word vector.

13. The computer program product of claim 12, wherein building the multidimensional word vector comprises:
collecting a plurality of bidded terms having corresponding group identifiers;
grouping bidded terms from among the plurality of bidded terms that have a common group identifiers to form term sequences;
inputting the term sequences into a deep learning network to embed each term in a multidimensional word vector in which related terms are found close to one another.

14. The computer program product of claim 10, wherein the input term comprises a bidded term and the plurality of nearest neighbors comprises recommended bidded terms.

15. The computer program product of claim 10, wherein the bidded term comprises a multi-word phrase.

16. The system of claim 1, wherein at least one bidded term is a multiword phrase.

17. The system of claim 1, wherein the learning module operates on the plurality of word sequences in a sliding window fashion.

18. The system of claim 1, wherein each sequence of words is a context.
